(19) United States
(12) Patent Application Publication
(10) Pub. No.: US 2019/0257241 A1
(43) Pub. Date: Aug. 22, 2019

(54) METHOD FOR OPERATING AN INTERNAL COMBUSTION ENGINE

(71) Applicant: Volkswagen Aktiengesellschaft, Wolfsburg (DE)

(72) Inventor: Sebastian HEINKEN, Braunschweig (DE)

(73) Assignee: Volkswagen Aktiengesellschaft, Wolfsburg (DE)

(21) Appl. No.: 16/262,596

(22) Filed: Jan. 30, 2019

(30) Foreign Application Priority Data
Feb. 19, 2018 (DE) 10 2018 202 477.4

(51) Int. Cl. F02B 37/12; F02D 41/00; F02D 37/00; G01M 15/05; G01M 15/06; G01M 15/10; F01N 11/00

(52) U.S. Cl. CPC F02B 37/12; F02D 41/0007; F02D 37/00; F02D 2041/281; G01M 15/06; G01M 15/106; F01N 11/002; G01M 15/05

(57) ABSTRACT

A method for operating an internal combustion engine having an exhaust gas line that conducts an exhaust gas, starting from the internal combustion engine, across an exhaust gas turbocharger, wherein a second pressure in a second section of the exhaust gas line downstream from the exhaust gas turbocharger is determined by measuring a first pressure in a first section of the exhaust gas line downstream from the internal combustion engine and upstream from the exhaust gas turbocharger; wherein this determination of the second pressure is derived from the condition that in certain operating points of the internal combustion, the first pressure corresponds to the second pressure at certain crankshaft angle positions.

### FIELD OF THE INVENTION

The invention relates to a method for operating an internal combustion engine having an exhaust gas line that conducts an exhaust gas, starting from the internal combustion engine, across an exhaust gas turbocharger and to the surroundings. In particular, the method may be used in motor vehicles for controlling operation of the internal combustion engine. In addition, by use of the method an exhaust gas back pressure in the exhaust gas line may be determined, and loading of an exhaust gas treatment component (a particle filter, for example) with soot may be determined via the change in the exhaust gas back pressure.

### BACKGROUND OF THE INVENTION

In internal combustion engines having exhaust gas turbochargers, a first section of the exhaust gas line is situated downstream from the internal combustion engine and upstream from the exhaust gas turbocharger, and a second section of the exhaust gas line is situated downstream from the exhaust gas turbocharger. In internal combustion engines, a pressure sensor may be situated in the first section, for example in an exhaust manifold of the internal combustion engine.

Furthermore, the internal combustion engine is controlled during operation. In particular the following controls are carried out: control of a charge pressure for the internal combustion engine; control of a charge cycle model (i.e., the supplying of fresh air, exhaust gas, and fuel for combustion in the combustion chambers of the internal combustion engine and also discharging the exhaust gas from combustion chambers, as well as the ignition points, the valve opening times, etc.) of the internal combustion engine; diagnosis of exhaust gas turbocharger overspeed; control of a regeneration of a gas treatment component situated in the second section. These controls are in particular a function of an exhaust gas back pressure that is present in the second section of the exhaust gas line downstream from the exhaust gas turbocharger.

However, providing a pressure sensor in this poorly accessible part of the exhaust gas line is labor- and cost-intensive. For this reason, approaches are known from the prior art for estimating the exhaust gas back pressure in the second section.

A method is known from EP 1 491 747 A2 for determining an exhaust gas back pressure by computation.

These estimation or computation methods, at least in some operating situations, are too imprecise for controlling the internal combustion engine.

### SUMMARY OF THE INVENTION

The object of the present invention is to at least partially solve the problems described with regard to the prior art. In particular, the aim is to provide a method by means of which the most accurate determination possible of the exhaust gas back pressure present in a second section, i.e., downstream from an exhaust gas turbocharger, may be made. The exhaust gas back pressure thus determined may be utilized for the various controls of the internal combustion engine, thus enabling effective operation of the internal combustion engine.

This object is achieved with the assistance of a method having the features according to the independent claims. Advantageous refinements are the subject matter of the dependent patent claims. The features individually stated in the patent claims may be combined with one another in a technologically meaningful way, and may be supplemented by illustrative information from the description and/or details from the figures in which further embodiment variants of the invention are shown.

A method for operating an internal combustion engine having an exhaust gas line is proposed. The exhaust gas line conducts an exhaust gas, starting from the internal combustion engine, across an exhaust gas turbocharger (for example, to the surroundings, or optionally at least partially back to the internal combustion engine via an exhaust gas return line). By measuring a first pressure in a first section of the exhaust gas line downstream from the internal combustion engine and upstream from the exhaust gas turbocharger (for example, by means of a pressure sensor, i.e., a first sensor), a second pressure in a second section of the exhaust gas line downstream from the exhaust gas turbocharger is determined. The determination of the second pressure is derived from the condition or relationship according to which the first pressure in predetermined operating points of the internal combustion engine corresponds (essentially) to the second pressure at predetermined crankshaft angle positions.

In other words, the method (alternatively or additionally) may be described as follows:

At least measuring the first pressure and second pressure during multiple operating points of the internal combustion engine and multiple crankshaft angle positions of the internal combustion engine,

Identifying at least one operating point and one crankshaft angle position of the internal combustion engine for which the first pressure and the second pressure essentially match, and establishing this crankshaft angle position or this operating point as the basis for control,

Controlling the operation of the internal combustion engine based on measured first pressures and as a function of second pressures that are specified by the basis for control.

Steps 1 and 2 may be carried out (once) in an initiation process (on a test stand, for example), while step 3 may be carried out in the motor vehicle during (driving) operation of the internal combustion engine.

The identification of the “matching” pressures may take place in such a way that a predefined maximum deviation, resulting from a comparison of the first pressure and the second pressure, is not exceeded. The predefined maximum deviation may be 2%, 1%, or even 0.5%, for example.

Establishing the basis for control may take place in the form of a characteristic curve, wherein the identified crankshaft angle positions and/or operating points are at least one support or reference variable.

Prior to step 3, an optionally provided (pressure) sensor in the second section may be removed. It is possible for a sensor for measuring the first pressure to be provided and used only in the first section.

The second section in particular extends, starting from the exhaust gas turbocharger, further downstream, in particular along the main exhaust system until reaching the surroundings. In particular, at least one gas treatment component (particle filter, catalytic converter, flow influencer, injection device, heating device, etc.) is situated in the second section.

The second pressure is to be determined in particular between the exhaust gas turbocharger and a gas treatment component situated closest downstream from the exhaust gas turbocharger.

The first pressure in the first section varies in particular as a function of the particular operating point that is present and the crankshaft angle position (in the particular operating point). The exhaust valves of the combustion chambers are actuated as a function of the crankshaft angle position, so that exhaust gas from the combustion chambers can enter the first section. It has now been established that in operating points to be specifically determined, and for certain crankshaft angle positions that are then actually present, the first pressure upstream from the exhaust gas turbocharger has the same magnitude as the second pressure downstream from the exhaust gas turbocharger. In addition, it has been established that this point in time in the first course of the first pressure may be determined very accurately, so that the second pressure may be derived from the first course of the first pressure with great accuracy.

In addition, it is known that the second pressure has a certain second course as a function of the course of the measured first pressure.

Based on these conditions, it has been deduced in particular that the second course of the second pressure may be determined as a function of the first course of the measured first pressure. In addition, based on a change in the measured first pressure, in particular in the certain operating points and for the certain crankshaft angle positions, it is possible to determine a change in the second pressure, and thus an instantaneously present exhaust gas back pressure in the second section of the exhaust gas line.

The exhaust gas back pressure that is (accurately) determined in this way may be utilized in particular for controlling the internal combustion engine, for example. In addition, a change in the exhaust gas back pressure may be determined via the change in the measured first pressure, and thus, the determined second pressure. The change in the exhaust gas back pressure is caused in particular by increasing loading, for example soot loading of a gas treatment component situated in the second section. In particular the state of the gas treatment component (for example, a pressure drop across the gas treatment component) may be determined via the established change in the exhaust gas back pressure. A point in time for a regeneration of the gas treatment component may preferably be determined. In addition, the effectiveness of the regeneration may be checked via the instantaneously present exhaust gas back pressure.

In particular, it is proposed that the internal combustion engine is operated on a test stand, using a test stand method, for determining the operating points and the crankshaft angle positions.

In a test stand method, a second (pressure) sensor may be situated in the second section, and the second pressure and the second course in the second section may thus be detected by measurement. Thus, in the test stand method, for each configuration of the internal combustion engine, exhaust gas line, gas treatment components, drive train (for example, transmission, additional drive units, etc.), the operating points and crankshaft angle positions for which the magnitudes of the first pressure and the second pressure are equal may be determined.

The operating points and crankshaft angle positions thus determined in the test stand method may then be used in particular in the method described above, so that the internal combustion engine, manufactured in large production volumes, of the same type as the configuration used in the test stand method may be used without a second sensor.

The operating point of the internal combustion engine is in particular a function of the instantaneously present operating parameters of the internal combustion engine (ignition points, injection quantity, compression ratio, etc.), an exhaust gas mass flow, a position of an actuator of the turbocharger, and a position of a camshaft.

In particular, for the test stand method a state of the exhaust gas line downstream from the exhaust gas turbocharger with regard to a flow resistance and a resulting instantaneous exhaust gas back pressure in the second section is known (or is determined within the scope of the test stand method). The test stand method includes at least the following steps:

Measuring a course of the first pressure during operation of the internal combustion engine, using a first sensor;

Measuring a course of the second pressure during operation of the internal combustion engine, using a second sensor;

Determining the operating points and the crankshaft angle positions for which the first pressure (essentially) corresponds to the second pressure.

The state of the exhaust gas line includes, for example, the loading of the at least one gas treatment component in the second section. The state includes in particular the knowledge of all factors that affect the exhaust gas back pressure in the second section. In particular, these are (exclusively) factors that do not change, for example when a gas is passed through (without soot, or reaction in one of the gas treatment components, or interaction with the second section of the exhaust gas line).

In particular, based on the knowledge that the first pressure or the first course changes starting from this known state, conclusions may be drawn concerning one or more reasons for the change, derived therefrom, in the second pressure or the second course. In particular, a loading state of a gas treatment component (a particle filter, for example) may thus be determined.

Based on step c), a characteristic curve for an adaptation value may preferably be determined, by means of which, for other operating points of the internal combustion engine, a second pressure is determined from the measurement of the first pressure. This characteristic curve includes in particular the operating points and crankshaft angle positions determined in step c) as interpolation points, and from this information is generated for other operating points. By use of the adaptation value, it is in particular possible to likewise determine in these other operating points the second pressure, starting from the measured first pressure.

In particular, during operation of the internal combustion engine the second pressure, and thus an instantaneous exhaust gas back pressure in the second section, is determined based on a change in the first pressure.

The instantaneous exhaust gas back pressure may be used at least for the following control methods:

Controlling a charge pressure for the internal combustion engine (in particular the provided pressure on the fresh air side of the internal combustion engine);

Controlling a charge cycle model of the internal combustion engine (in particular, controlling the supplying of fresh air, exhaust gas, and fuel for combustion in the combustion chambers of the internal combustion engine and also discharging the exhaust gas from combustion chambers, as well as the ignition points, the valve opening times, etc.);

Correcting the charge cycle model based on the instantaneous exhaust gas back pressure;

Diagnosing an exhaust gas turbocharger component (for example, analyzing the exhaust gas turbocharger speed to avoid exceeding predetermined limiting speeds; protecting the exhaust gas turbocharger from mechanical and/or thermal damage);

Controlling a regeneration of a gas treatment component situated in the second section (for example, a particle filter in which, for example, the temperature of the exhaust gas is at least temporarily increased, or additional oxygen and/or fuel are/is provided).

These controls are in particular a function of an exhaust gas back pressure that is present in the second section of the exhaust gas line downstream from the exhaust gas turbocharger.

In particular, at least one gas treatment component (a particle filter, for example) is situated in the second section, by means of which, in the second section upstream from the gas treatment component, the instantaneous exhaust gas back pressure is influenced as a function at least of loading of the gas treatment component with soot. In particular, the loading is determinable by ascertaining the instantaneous exhaust gas back pressure (or the second pressure). In particular, the effectiveness of a regeneration carried out on the particle filter may be checked in this way.

The loading of a particle filter, for example, refers in particular to the quantity or mass of solids (such as soot particles) that are stored in the particle filter at a given moment. A particle filter in the present sense refers in particular to a so-called wall-flow filter, i.e., a component having a plurality of channels (in the manner of a honeycomb structure, for example) which in particular are closed in alternation, and which thus require penetration of the exhaust gas together with the solids through a gas-permeable or porous wall. The solids are hereby deposited and/or retained on or in the walls. The walls or channels become clogged with increasing loading.

Furthermore, a computer program is proposed which is configured for carrying out the method described above. In particular, an engine control is proposed which at least partially carries out the method proposed herein.

Furthermore, a machine-readable memory medium (for example, in a control unit associated with the internal combustion engine) is proposed on which the above-described computer program is stored.

Furthermore, an internal combustion engine having an exhaust gas line is proposed, through which an exhaust gas, starting from the internal combustion engine, is conductible across an exhaust gas turbocharger. The internal combustion engine in particular is provided for installation in a motor vehicle or is situated in a motor vehicle.

The exhaust gas line has a first section downstream from the internal combustion engine and upstream from the exhaust gas turbocharger, and a second section downstream from the exhaust gas turbocharger. A first sensor for measuring a first pressure is situated in the first section. The internal combustion engine also includes a control unit that is suitable for carrying out the method described above, or is suitably designed and configured, or carries out or may carry out the method.

The method is usable in particular for all types of internal combustion engines (gasoline engine, diesel engine, etc.), and in particular in combination with other drive units (electric drives).

The statements concerning the proposed method are transferable to the proposed internal combustion engine, the computer program, and the memory medium, and conversely.

As a precaution, it is noted that the ordinal numbers used herein (“first,” “second,” . . . ) are used primarily (only) to distinguish between multiple similar objects, variables, or processes; i.e., in particular no dependency and/or sequence of these objects, variables, or processes relative to one another are/is necessarily specified. If a dependency and/or sequence is necessary, this is explicitly indicated herein, or is readily apparent to those skilled in the study of the embodiment specifically described.

### BRIEF DESCRIPTION OF THE DRAWINGS

The invention and the technical context are explained in greater detail below with reference to the figures. It is pointed out that the invention is not to be construed as being limited by the illustrated exemplary embodiments. In particular, unless explicitly stated otherwise, it is also possible to extract partial aspects of the information shown in the figures and combine them with other components and findings from the present description and/or figures. In particular, it is noted that the figures and in particular the illustrated proportions are only schematic. Identical objects are denoted by the same reference numerals, so that explanations concerning other figures may possibly be supplementally used. In the figures:

FIG. 1: shows an internal combustion engine having an exhaust gas line; and

FIG. 2: shows a pressure-time diagram.

### DETAILED DESCRIPTION OF THE INVENTION

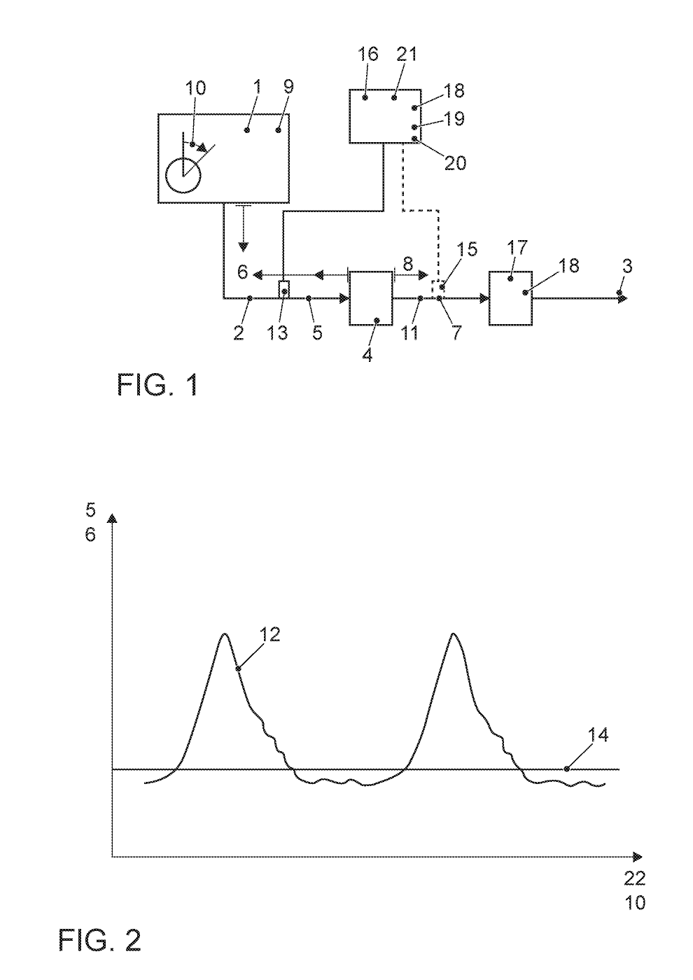

FIG. 1 shows an internal combustion engine 1 having an exhaust gas line 2. Starting from the internal combustion engine 1, an exhaust gas 3 is conducted through the exhaust gas line 2 and across an exhaust gas turbocharger 4. The exhaust gas line 2 has a first section 6 downstream from the internal combustion engine 1 and upstream from the exhaust gas turbocharger 4, and a second section 8 downstream from the exhaust gas turbocharger 4. A first sensor 13 for measuring a first pressure 5 is situated in the first section 6. The internal combustion engine 1 also includes a control unit 21 that is suitable for carrying out the described method.

A second pressure 7 in a second section 8 of the exhaust gas line 2 downstream from the exhaust gas turbocharger 4 is determined by measuring a first pressure 5 in a first section 6 of the exhaust gas line 2. This determination of the second pressure 7 is derived from the condition that in certain operating points 9 of the internal combustion engine 1, the first pressure 5 corresponds to the second pressure 7 at certain crankshaft angle positions 10.

A gas treatment component 17 (particle filter, catalytic converter, flow influencer, injection device, heating device, etc.) is situated in the second section 8.

In a test stand method, a second (pressure) sensor 15 (indicated here by dashed lines) may be situated in the second section 8, and the second pressure 7 and the second course 14 in the second section 8 may thus be detected by measurement. Thus, in the test stand method, for each configuration of the internal combustion engine 1, exhaust gas line 2, gas treatment components 17, drive train (for example, transmission, additional drive units, etc.), the operating points 9 and crankshaft angle positions 10 for which the magnitudes of the first pressure 5 and the second pressure 7 are equal may be determined.

The operating points 9 and crankshaft angle positions 10 thus determined in the test stand method may then be used in the method described above, so that the internal combustion engine 1, manufactured in large production volumes, of the same type as the configuration used in the test stand method may be used without a second sensor 15.

In the second section 8, a gas treatment component 4 [sic; 17] (a particle filter, for example) is situated in the second section 8, by means of which, in the second section 8 upstream from the gas treatment component 4 [sic; 17], the instantaneous exhaust gas back pressure 11 is influenced as a function at least of loading 18 of the gas treatment component 17 with soot. The loading 18 is determinable by ascertaining the instantaneous exhaust gas back pressure 11 (or the second pressure 7).

The control unit 21 is able to detect the pressures 5, 7. The computer program 19, which is stored on a machine-readable memory medium 20, is stored in the control unit 21. The characteristic curve 16 is also stored in the control unit 21.

FIG. 2 shows a pressure-time diagram. The pressure 5, 7 is plotted on the vertical axis. Time 22 and the recurring crankshaft angle position 10 [are plotted] on the horizontal axis.

The first pressure 5 in the first section 6 varies as a function of the particular operating point 9 that is present, and the crankshaft angle position 10 (in the particular operating point 9). The exhaust valves of the combustion chambers are actuated as a function of the crankshaft angle position 10, so that exhaust gas 3 from the combustion chambers can enter the first section 6. It has now been established that in certain operating points 9, and for certain crankshaft angle positions 10 that are then present, the first pressure 5 upstream from the exhaust gas turbocharger 4 has the same magnitude as the second pressure 7 downstream from the exhaust gas turbocharger 4 (see intersection points of the first course 12 of the first pressure 5 and of the second course 14 of the second pressure 7). In addition, it has been established that this point in time in the first course 12 of the first pressure 5 may be determined very accurately, so that the second pressure 7 may be derived from the first course 12 of the first pressure 5 with great accuracy.

In addition, it is known that the second pressure 7 has a certain second course 14 as a function of the first course 12 of the first pressure 5.

Based on these conditions, it has been deduced that the second course 14 of the second pressure 7 may be determined as a function of the first course 12 of the first pressure 5. In addition, based on a change in the first pressure 5, in particular in the certain operating points 9 and at the certain crankshaft angle positions 10, it is possible to determine a change in the second pressure 7, and thus an instantaneously present exhaust gas back pressure 11 in the second section 8 of the exhaust gas line 2.

### LIST OF REFERENCE NUMERALS

1 internal combustion engine
2 exhaust gas line
3 exhaust gas
4 exhaust gas turbocharger
5 first pressure
6 first section
7 second pressure
8 second section
9 operating point
10 crankshaft angle position
11 exhaust gas back pressure
12 first course
13 first sensor
14 second course
15 second sensor
16 characteristic curve
17 gas treatment component
18 loading
19 computer program
20 machine-readable memory medium
21 control unit
22 time

1. A method for operating an internal combustion engine comprising an exhaust gas line that conducts an exhaust gas, starting from the internal combustion engine, across an exhaust gas turbocharger, the method comprising:
determining a second pressure, in a second section of the exhaust gas line downstream from the exhaust gas turbocharger, by measuring a first pressure, in a first section of the exhaust gas line downstream from the internal combustion engine and upstream from the exhaust gas turbocharger;
wherein the determination of the second pressure is derived from a relationship according to which the first pressure in predetermined operating points of the internal combustion engine corresponds to the second pressure at predetermined crankshaft angle positions.

2. The method according to claim 1, further comprising determining the predetermined operating points and the predetermined crankshaft angle positions by operating the internal combustion engine on a test stand, using a test stand method.

3. The method according to claim 2, wherein the test stand method comprises:
measuring a first course of the first pressure during operation of the internal combustion engine, using a first sensor; and
measuring a second course of the second pressure during operation of the internal combustion engine, using a second sensor;
wherein determining the predetermined operating points and the predetermined crankshaft angle positions comprises determining operating points and crankshaft angle positions for which the first pressure corresponds to the second pressure; and
wherein, for the test stand method, a state of the exhaust gas line downstream from the exhaust gas turbocharger with regard to a flow resistance and a resulting instantaneous exhaust gas back pressure in the second section is known.

4. The method according to claim 3, further comprising:
determining a characteristic curve for an adaptation value based on the determination of the predetermined operating points and the predetermined crankshaft angle positions; and
determining, for other operating points of the internal combustion engine, a third pressure, in the second section of the exhaust gas line downstream from the exhaust gas turbocharger, from the measurement of the first pressure based on the characteristic curve for the adaption value.

5. The method according to claim 3, further comprising, during operation of the internal combustion engine, determining the second pressure and the instantaneous exhaust gas pressure based on a change in the first pressure.

6. The method according to claim 5, further comprising a control method comprising, using the instantaneous exhaust gas back pressure for:
controlling a charge pressure for the internal combustion engine;
controlling a charge cycle model of the internal combustion engine;
diagnosing an exhaust gas turbocharger overspeed; and
controlling a regeneration of a gas treatment component situated in the second section.

7. The method according to claim 5, further comprising determining a loading of at least one gas treatment component with soot by ascertaining the instantaneous exhaust gas back pressure, in the second section upstream from the gas treatment component; wherein the instantaneous exhaust gas back pressure is influenced as a function at least of the loading of the gas treatment component.

8. A computer program that is configured to execute the method according to claim 1.

9. A machine-readable memory medium comprising the computer program according to claim 8.

10. An internal combustion engine comprising:
an exhaust gas line configured to conduct an exhaust gas, starting from the internal combustion engine, across an exhaust gas turbocharger, wherein the exhaust gas line has:
a first section downstream from the internal combustion engine and upstream from the exhaust gas turbocharger, and
a second section downstream from the exhaust gas turbocharger;
a first sensor, situated in the first section, for measuring a first pressure; and
a control unit configured to determine a second pressure, in the second section, by measuring the first pressure, wherein the determination of the second pressure is derived from a relationship according to which the first pressure in predetermined operating points of the internal combustion engine corresponds to the second pressure at predetermined crankshaft angle positions.

11. The internal combustion engine of claim 10, wherein the control unit is further configured to perform a test stand method comprising:
measure a first course of the first pressure during operation of the internal combustion engine, using a first sensor; and
measure a second course of the second pressure during operation of the internal combustion engine, using a second sensor;
wherein the predetermined operating points and the predetermined crankshaft angle positions are predetermined by determining operating points and crankshaft angle positions for which the first pressure corresponds to the second pressure; and
wherein, for the test stand method, a state of the exhaust gas line downstream from the exhaust gas turbocharger with regard to a flow resistance and a resulting instantaneous exhaust gas back pressure in the second section is known.

12. The internal combustion engine of claim 11, wherein the control unit is further configured to:
determine a characteristic curve for an adaptation value based on the determination of the predetermined operating points and the predetermined crankshaft angle positions; and
determine, for other operating points of the internal combustion engine, a third pressure, in the second section of the exhaust gas line downstream from the exhaust gas turbocharger, from the measurement of the first pressure based on the characteristic curve for the adaption value.

13. The internal combustion engine of claim 11, wherein the control unit is further configured to, during operation of the internal combustion engine, determine the second pressure and the instantaneous exhaust gas pressure based on a change in the first pressure.

14. The internal combustion engine of claim 13, wherein the control unit is further configured to, utilize the instantaneous exhaust gas back pressure to:
control a charge pressure for the internal combustion engine;
control a charge cycle model of the internal combustion engine;
diagnose an exhaust gas turbocharger overspeed; and
control a regeneration of a gas treatment component situated in the second section.

15. The internal combustion engine of claim 13, wherein the control unit is further configured to determine a loading of at least one gas treatment component with soot by ascertaining the instantaneous exhaust gas back pressure, in the second section upstream from the gas treatment component; wherein the instantaneous exhaust gas back pressure is influenced as a function at least of the loading of the gas treatment component
